(19) United States
(12) Patent Application Publication
(10) Pub. No.: US 2026/0208647 A1
(43) Pub. Date: Jul. 23, 2026

(54) VEHICLE-MOUNTED HEADREST

(71) Applicant: Qinglv Long, Dongguan (CN)

(72) Inventor: Qinglv Long, Dongguan (CN)

(21) Appl. No.: 19/203,277

(22) Filed: May 9, 2025

(30) Foreign Application Priority Data
Jan. 18, 2025 (CN) 202510079519.1

(51) Int. Cl. B60N 2/885; B60N 2/815; B60N 2/865; B60N 2/882

(52) U.S. Cl. CPC B60N 2/885; B60N 2/815; B60N 2/865; B60N 2/882

(57) ABSTRACT

Disclosed in the present disclosure is a vehicle-mounted headrest, comprising a base, and a left side pillow assembly and a right side pillow assembly that are fixedly or detachably connected to two opposite ends of the base, where the left side pillow assembly and the right side pillow assembly have the same mirror image or non-mirror image structure. According to the present disclosure, a sliding hole is provided in each connecting rod, and each side pillow is connected to the corresponding connecting rod in an up-and-down sliding manner through a connecting mechanism, such that a user can adjust heights of the side pillows, the side pillows can be more closely attached to both sides of a head of the user, comfort of use is improved, and applicability is stronger.

### CROSS-REFERENCE TO RELATED APPLICATIONS

This application claims to the benefit of priority from Chinese Application No. 202510079519.1 with a filing date of Jan. 18, 2025, the content of the aforementioned applications, including any intervening amendments thereto, are incorporated herein by reference.

### TECHNICAL FIELD

The present disclosure relates to the technical field of headrests, and in particular to a vehicle-mounted headrest.

### BACKGROUND

A vehicle-mounted headrest is a device mounted on a vehicle seat and used for supporting a left side and a right side of a head of a user, which provides a driver who drives a vehicle or a passenger who takes the vehicle for a long distance with very good experience, and is deeply liked by the user.

However, for a common vehicle-mounted headrest, a side pillow and a connecting rod of the common vehicle-mounted headrest are designed to be fixed, such that an upper position and a lower position and a supporting angle of the side pillow cannot be adjusted (in practical use, due to differences in sitting habits and heights of various drivers, it is difficult for the users to buy vehicle-mounted headrests suitable for their sitting habits and heights). Therefore, the comfort and applicability of the common vehicle-mounted headrest need to be modified and improved.

### SUMMARY

An objective of the present disclosure is to provide a vehicle-mounted headrest, which aims at solving the problem that an upper position and a lower position and a supporting angle of a side pillow of the existing vehicle-mounted headrest cannot be adjusted due to the fixation design between the side pillow and a connecting rod.

The present disclosure is implemented as follows:

A vehicle-mounted headrest, including a base, and a left side pillow assembly and a right side pillow assembly that are fixedly or detachably connected to two opposite ends of the base, where the left side pillow assembly and the right side pillow assembly have the same mirror image or non-mirror image structure.

The left side pillow assembly includes a connecting rod, a side pillow and a connecting mechanism fixedly arranged on the side pillow, the side pillow on the left side pillow assembly and the side pillow on the right side pillow assembly are used for forming a supporting effect on a left side and a right side of a head of a user, a sliding hole with a certain length is provided in each connecting rod, and the side pillow slides up and down along the corresponding sliding hole and is rotationally connected on the corresponding connecting rod in a horizontal direction.

Preferably, each connecting mechanism includes a cover plate, a release key, a bottom seat, a fixed seat and a first elastic body, where the release key is arranged above the bottom seat, the fixed seat is fixedly mounted on the side pillow, a rotating groove is provided at the fixed seat, and the bottom seat is mounted in the rotating groove and rotationally connected to the fixed seat.

Preferably, first teeth are arranged on an inner side of the sliding hole and closest to an edge of an opening of the sliding hole at equal intervals, and the first teeth are arranged at an upper end and a lower end of the sliding hole or at any one of the upper end and the lower end.

Preferably, the bottom seat is provided with a mounting cavity with a certain depth, the first elastic body and the release key are both arranged in the mounting cavity, the first elastic body is arranged below the release key, and one end of the first elastic body elastically abuts against the release key.

Preferably, the release key includes second teeth arranged on the release key and a raised key column, the key column penetrates the corresponding cover plate, the second teeth on the release key are arranged corresponding to the first teeth on the sliding hole, the second teeth are meshed with the first teeth, and when the second teeth are meshed with the first teeth, a stroke of sliding up and down of the side pillow is locked.

Preferably, the bottom seat is in a T-shaped structure, one end of the bottom seat passes through the sliding hole in the connecting rod, the cover plate is fixedly connected to the bottom seat through a screw or buckle, and a gap with a certain width is provided between the cover plate and the bottom seat so as to facilitate upward and downward sliding of the connecting mechanism.

Preferably, each connecting mechanism further includes several damping assemblies, the damping assemblies are embedded at a bottom of the bottom seat, and the damping assemblies are arranged to increase damping force when the side pillow rotates in the horizontal direction.

Preferably, each damping assembly includes a housing body, and a second elastic body and a ball that are arranged inside the housing body, the ball is arranged above the second elastic body, and the ball elastically abuts against the second elastic body.

Preferably, several hemispherical grooves are circularly at a bottom of the rotating groove, the hemispherical grooves are provided corresponding to the damping assemblies one by one, and when the balls on the damping assemblies are clamped into the hemispherical grooves, a rotation angle of the side pillow in the horizontal direction is locked.

Preferably, the bottom seat is circularly provided with first tooth patterns, the fixed seat is provided with second tooth patterns corresponding to the first tooth patterns, and the first tooth patterns are meshed with the second tooth patterns in a fitted manner. The bottom seat is provided with an avoidance groove with a certain depth, a connecting screw rod and a third elastic body arranged on the connecting screw rod in a sleeving manner are arranged in the avoidance groove, and the connecting screw rod penetrates the avoidance groove and is in threaded connection to the fixed seat. A bottom end of the third elastic body abuts against a bottom of the avoidance groove, and a top end of the third elastic body abuts against a screw cap of the connecting screw rod to form an elastic compression state for the bottom seat.

Compared with the prior art, the present disclosure has the beneficial effects as follows:
1. According to the present disclosure, the sliding hole is provided in each connecting rod, and each side pillow is connected to the corresponding connecting rod in an up-and-down sliding manner through the connecting mechanism, such that the user can adjust heights of the side pillows, the side pillows can be more closely attached to both sides of the head of the user, comfort of use is improved, and applicability is stronger.
2. According to the present disclosure, the connecting mechanisms are arranged, and the bottom seats and the fixed seats on the connecting mechanisms are rotationally connected, such that each side pillow fixedly connected to the corresponding fixed seat can rotate in the horizontal direction, a supporting angle of the side pillow can be adjusted, and the effect of being very practical is achieved.
3. The damping assemblies arranged on each connecting mechanism is used for making the corresponding side pillow have certain damping force during rotation, and a stroke angle of rotation of the side pillow can also be locked to prevent the side pillow from rotating at will, thereby improving user experience.

### BRIEF DESCRIPTION OF THE DRAWINGS

FIG. 1 is a schematic diagram of an integral structure of the present disclosure.

FIG. 2 is an exploded schematic structural diagram of a connecting mechanism in the present disclosure.

FIG. 3 is a cutaway view of a structure of a connecting mechanism in the present disclosure.

FIG. 4 is a perspective diagram of a left side pillow assembly in the present disclosure.

FIG. 5 is a schematic structural diagram of a connecting rod and a release key in the present disclosure.

FIG. 6 is a schematic diagram of an interior structure of a left side pillow assembly in the present disclosure.

FIG. 7 is a partial enlarged schematic diagram of FIG. 6 in the present disclosure.

FIG. 8 is a schematic structural diagram of a fixed seat in the present disclosure.

FIG. 9 is a schematic structural diagram of a bottom seat and a damping assembly in the present disclosure.

FIG. 10 is a cutaway view of a damping assembly in the present disclosure.

FIG. 11 is perspective schematic structural diagram I of a vehicle-mounted headrest in the present disclosure.

FIG. 12 is perspective schematic structural diagram II of a vehicle-mounted headrest in the present disclosure.

FIG. 13 is a schematic diagram of an interior structure of a left clamping arm assembly in the present disclosure.

FIG. 14 is a schematic structural diagram of a sliding groove in the present disclosure.

FIG. 15 is a schematic structural diagram of a bottom seat and a fixed seat in the present disclosure.

FIG. 16 is a cutaway view of an integral structure of a connecting mechanism in the present disclosure.

FIG. 17 is a schematic diagram of a mounting position of a connecting screw rod in a connecting mechanism of the present disclosure.

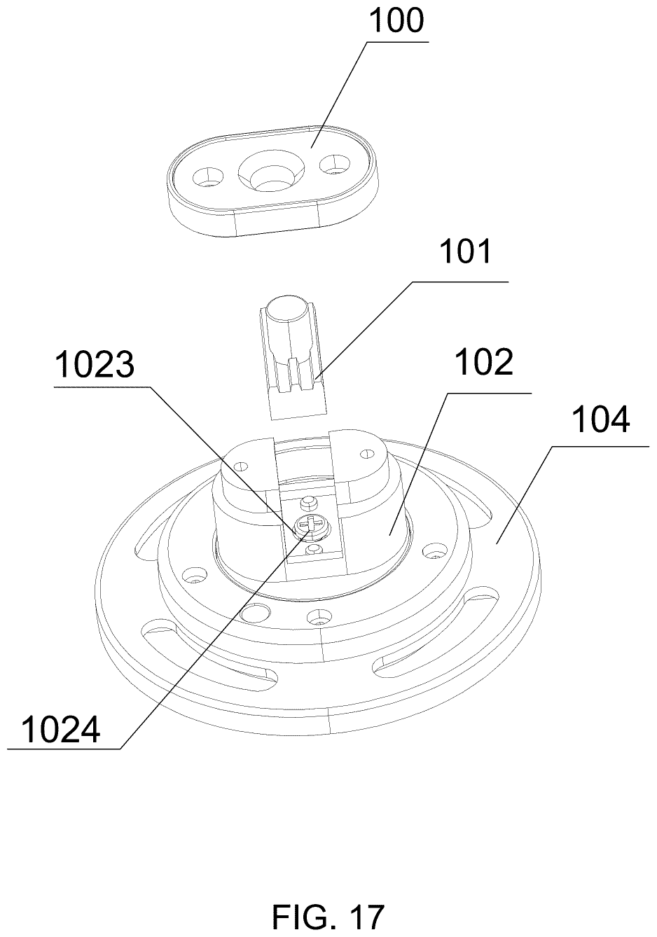

FIG. 18 is a schematic structural diagram of a connecting rod in the present disclosure.

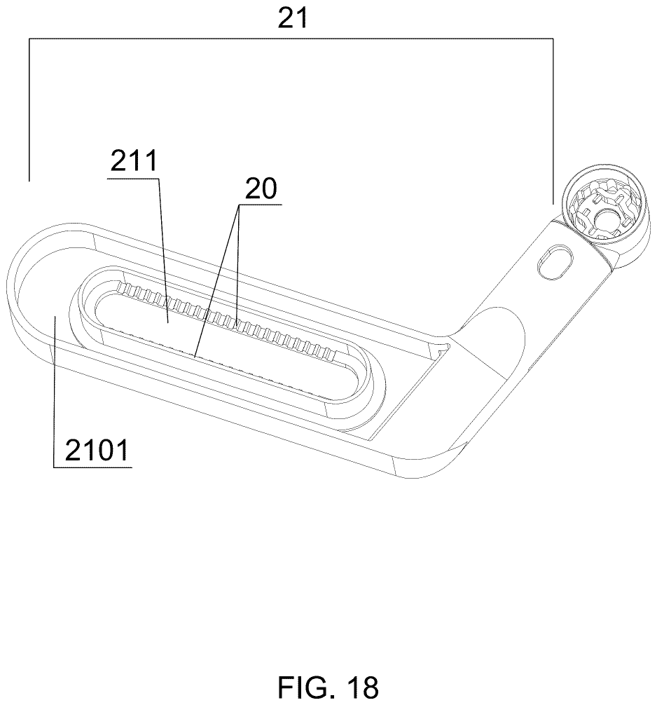

### DETAILED DESCRIPTIONS OF THE EMBODIMENTS

In the present disclosure, unless otherwise explicitly specified and defined, the terms “mounting”, “connecting”, “connection”, “fixing”, etc. should be understood in a broad sense, for example, they may denote fixed connection, detachable connection, or integrated connection, denote mechanical connection or electrical connection, denote direct connection or indirect connection via an intermediate medium, or denote communication between interiors of two elements or interaction between two elements. The specific meanings of the above terms in the present disclosure may be understood on a case-by-case basis for those of ordinary skill in the art.

A further specification is made below with reference to the accompanying drawings and in conjunction with particular examples:

### Example 1

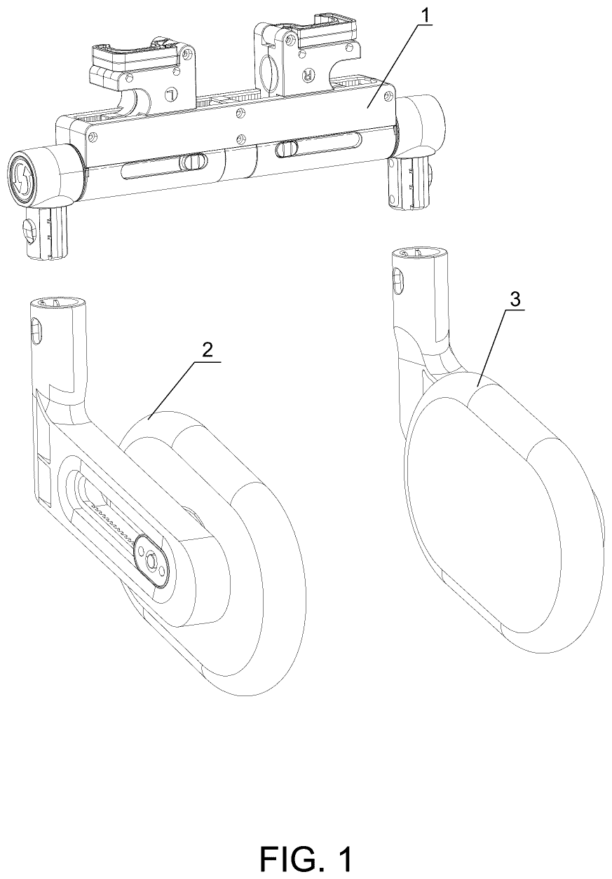

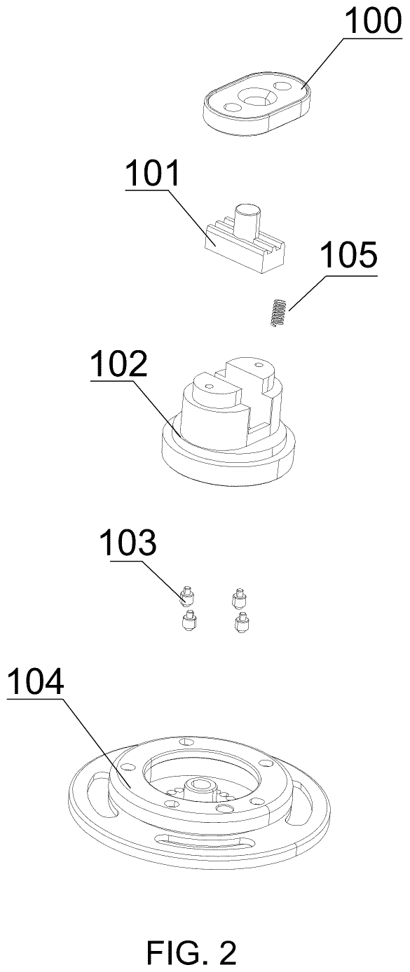

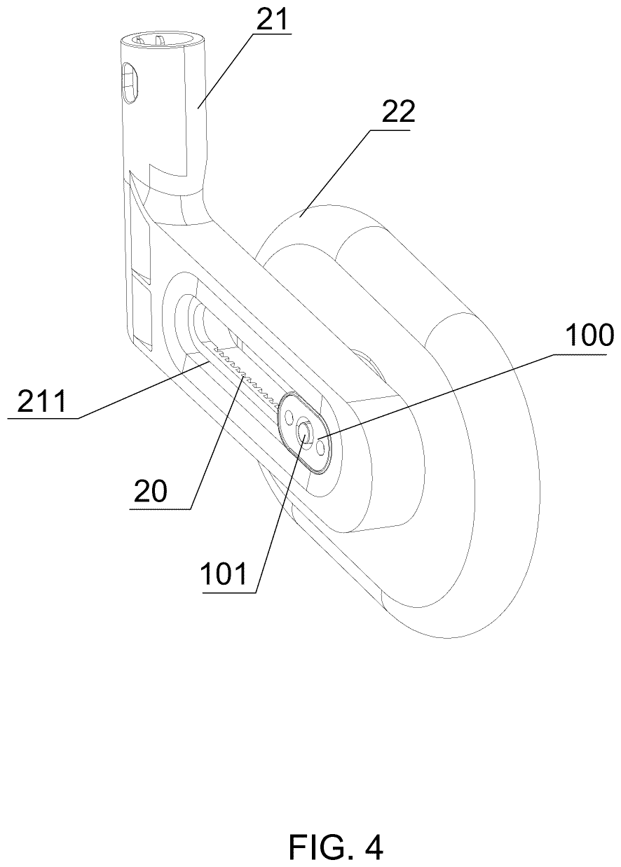

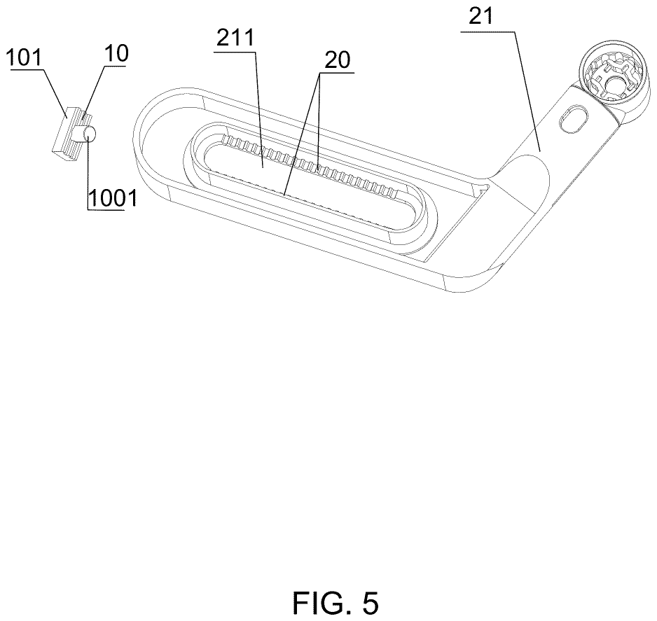

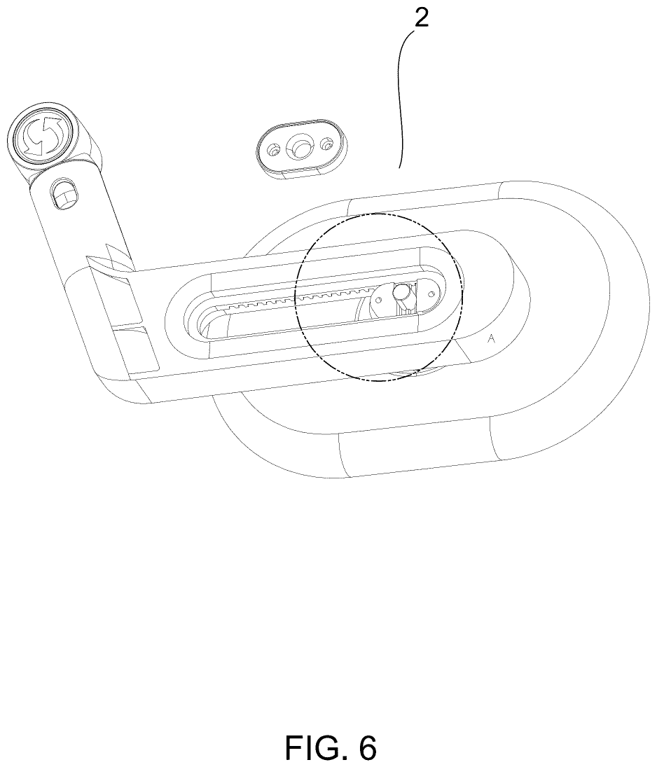

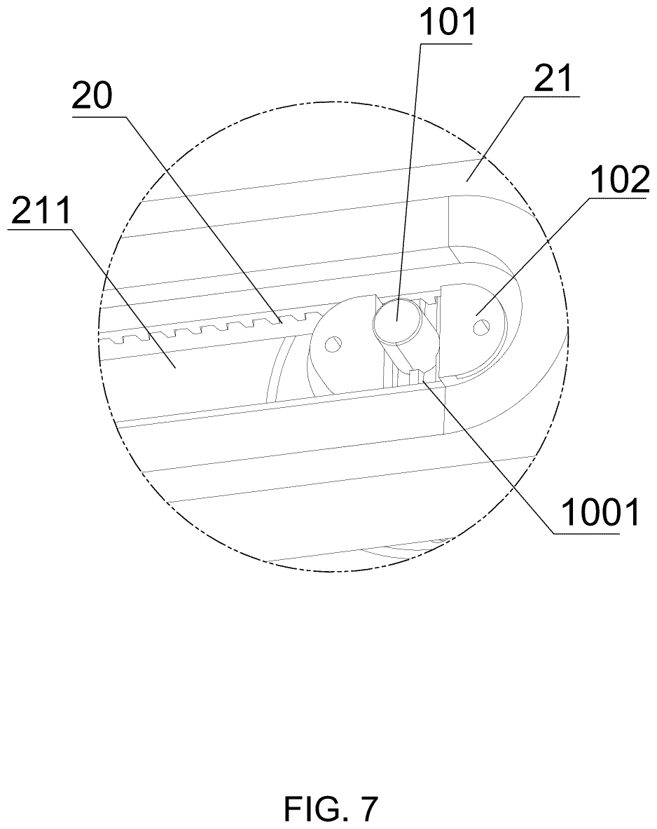

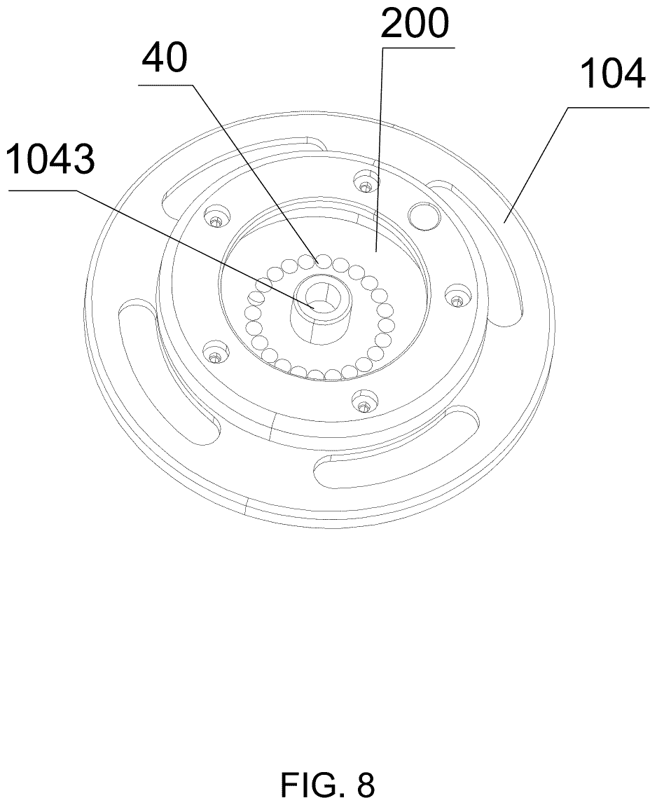

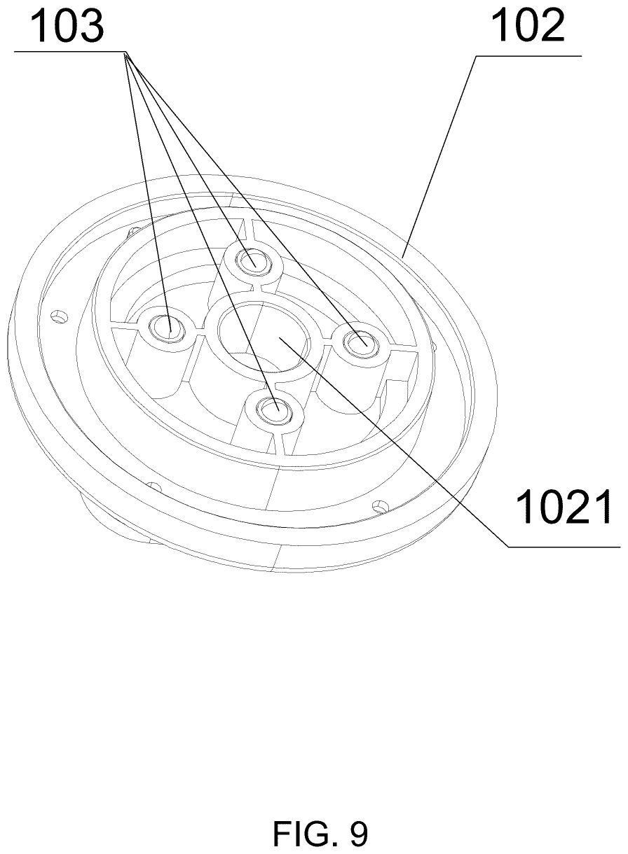

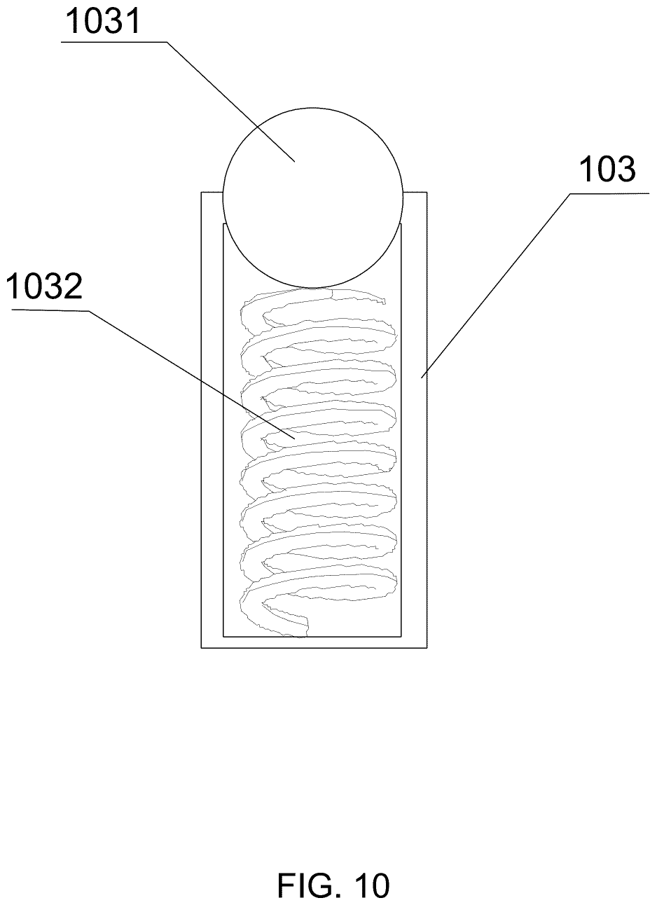

As shown in FIGS. 1-10, a vehicle-mounted headrest, including a base 1, and a left side pillow assembly 2 and a right side pillow assembly 3 that are fixedly or detachably connected to two opposite ends of the base 1, where the left side pillow assembly 2 and the right side pillow assembly 3 have the same mirror image or non-mirror image structure. The left side pillow assembly 2 includes a connecting rod 21, a side pillow 22 and a connecting mechanism fixedly arranged on the side pillow 22, and the side pillow 22 on the left side pillow assembly 2 and the side pillow 22 on the right side pillow assembly 3 are used for forming a supporting effect on a left side and a right side of a head of a user. A sliding hole 211 with a certain length is provided in each connecting rod 21, the connecting rod 21 is in a 7-shaped structure on the whole, one end of the connecting rod 21 is vertically upward and connected to the base 1, and the other end of the connecting rod 21 is oblique downward to be extended to form a connecting seat 2101. Each sliding hole 211 penetrates the corresponding connecting rod 21 and is provided in the corresponding connecting seat 2101, the sliding hole 211 is provided in a lengthwise direction of the connecting seat 2101, and the side pillow 22 slides up and down along the sliding hole 211 and is rotationally connected on the connecting rod 21 in a horizontal direction. In this example, the left side pillow assembly 2 and the right side pillow assembly 3 have the same mirror image structure, and a length of each sliding hole 211 is a maximum stroke distance for adjusting vertical heights of the left side pillow assembly 2 and the right side pillow assembly 3. When the height of a sitting posture or a height of the user cannot match the two side pillows 22 on the left and right and fails to achieve close attachment, the vertical heights of the two side pillows 22 on the left and right can be adjusted to adapt to drivers and passengers with different sitting postures and different heights.

Thus, the sliding hole 211 is provided in each connecting rod 21, and each side pillow 22 is connected to the corresponding connecting rod 21 in an up-and-down sliding manner through the connecting mechanism, such that the user can adjust the heights of the side pillows 22, supporting positions of the two side pillows 22 to the head of the user can also be adjusted by rotating the two side pillows 22 on the left and right in the horizontal direction so as to achieve the best use state when the side pillows 22 support the head of the user, and the side pillows can be more closely attached to both sides of the head of the user, thereby improving comfort of use, and making applicability be stronger.

As shown in FIGS. 1-10, each connecting mechanism includes a cover plate 100, a release key 101, a bottom seat 102, a fixed seat 104 and a first elastic body 105, where the release key 101 is arranged above the bottom seat 102, and the fixed seat 104 is fixedly mounted on the side pillow 22. The fixed seat 104 includes an upper housing 1041 and a bottom housing 1042 arranged above the upper housing 1041. A rotating groove 200 is provided at the fixed seat 104, and the rotating groove 200 is positioned between the upper housing 1041 and the bottom housing 1042. The rotating groove 200 is provided with a convex rotating shaft 1043, a position, corresponding to the rotating shaft 1043, at a bottom of the bottom seat 102 is provided with a shaft groove 1021, the rotating shaft 1043 is inserted into the shaft groove 1021, the shaft groove 1021 is positioned at a central position of the bottom seat 102, and the bottom seat 102 is mounted in the rotating groove 200 and rotationally connected to the fixed seat 104. The bottom seat 102 is provided with a mounting cavity with a certain depth, the first elastic body 105 and the release key 101 are both arranged in the mounting cavity, the first elastic body 105 is arranged below the release key 101, and one end of the first elastic body 105 elastically abuts against the release key 101. A spring or other structural body having certain elasticity and resilience serves as the first elastic body 105, and the first elastic body 105 is used for pressing and resetting the release key 101. First teeth 20 are arranged on an inner side of the sliding hole 211 and closest to an edge of an opening of the sliding hole 211 at equal intervals, and the first teeth 20 are arranged at an upper end and a lower end of the sliding hole 211 or at any one of the upper end and the lower end. In this example, the first teeth 20 are arranged in a straight line in a lengthwise direction of the sliding hole 211, and the first teeth 20 are positioned at an upper end and a lower end of the edge of the opening of an inner side of the sliding hole 211. The first teeth 20 are positioned at the inner side of the sliding hole 211, the cover plate 100 is located at an outer side of the sliding hole 211, and the first teeth and the cover plate are arranged oppositely. The release key 101 includes second teeth 10 arranged on the release key 101 and a raised key column 1001, the key column 1001 penetrates the corresponding cover plate 100, the second teeth 10 on the release key 101 and the first teeth 20 on the sliding hole 211 are correspondingly arranged, and the second teeth 10 are meshed with the first teeth 20. When the second teeth 10 are meshed with the first teeth 20, a stroke of sliding up and down of the side pillow 22 is locked. The bottom seat 102 is in a T-shaped structure, one end of the bottom seat 102 passes through the sliding hole 211 in the connecting rod 21, the cover plate 100 is fixedly connected to the bottom seat 102 through a screw or buckle, and a gap with a certain width is provided between the cover plate 100 and the bottom seat 102 so as to facilitate upward and downward sliding of the connecting mechanism.

Thus, when the user needs to adjust the vertical heights of the two side pillows 22 on the left and right, the user only needs to press the key column 1001 on the corresponding release key 101, the first elastic body 105 is deformed and retracted, and the second teeth 10 on the release key 101 are separated from the first teeth 20 on the connecting rod 21. In this case, the left side pillow assembly 2 and the right side pillow assembly 3 are unlocked, and the user can push the left pillow assembly 2 and the right pillow assembly 3 up and down to appropriate positions.

### Example 2

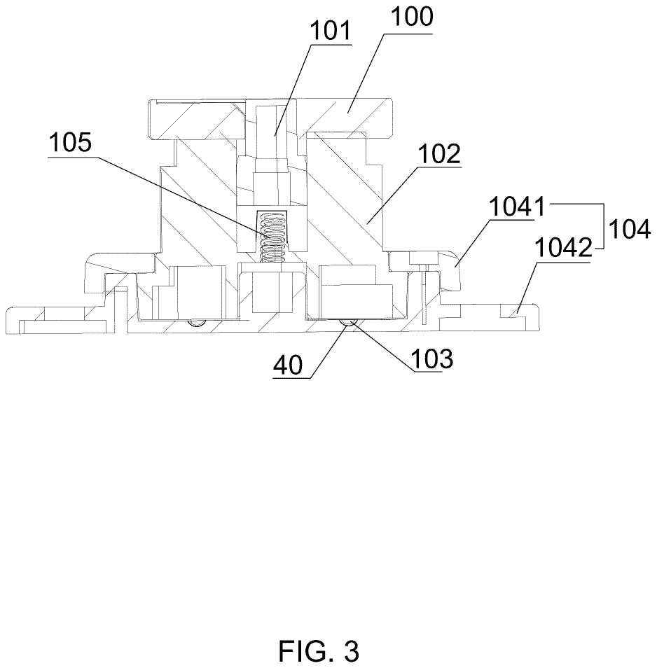

As shown in FIG. 1 and FIG. 3, a vehicle-mounted headrest, where each connecting mechanism further includes several damping assemblies 103, the damping assemblies 103 are embedded at a bottom of the bottom seat 102, and the damping assemblies 103 are arranged to increase damping force when the side pillow 22 rotates in the horizontal direction. Each damping assembly 103 includes a housing body, and a second elastic body 1031 and a ball 1032 that are arranged inside the housing body, the ball 1032 is arranged above the second elastic body 1031, and the ball 1032 elastically abuts against the second elastic body 1031. Several hemispherical grooves 40 are circularly at a bottom of the rotating groove 200, the hemispherical grooves 40 are provided corresponding to the damping assemblies 103 one by one, and when the balls 1032 on the damping assemblies 103 are clamped into the hemispherical grooves 40, a rotation angle of the side pillow 22 in the horizontal direction is locked. In this example, four damping assemblies 103 are arranged, and the hemispherical grooves 40 are circularly arranged on a periphery of the rotating shaft 1043.

Thus, the connecting mechanisms are arranged, and the bottom seats 102 and the fixed seats 104 on the connecting mechanisms are rotationally connected, such that each side pillow 22 fixedly connected to the corresponding fixed seat 104 can rotate in the horizontal direction, a supporting angle of the side pillow 22 can be adjusted, and the effect of being very practical is achieved.

Moreover, the damping assemblies 103 arranged on each connecting mechanism is used for making the corresponding side pillow 22 rotate with certain damping force, and a stroke angle of rotation of the side pillow 22 can also be locked to prevent the side pillow 22 from rotating at will, thereby improving user experience.

### Example 3

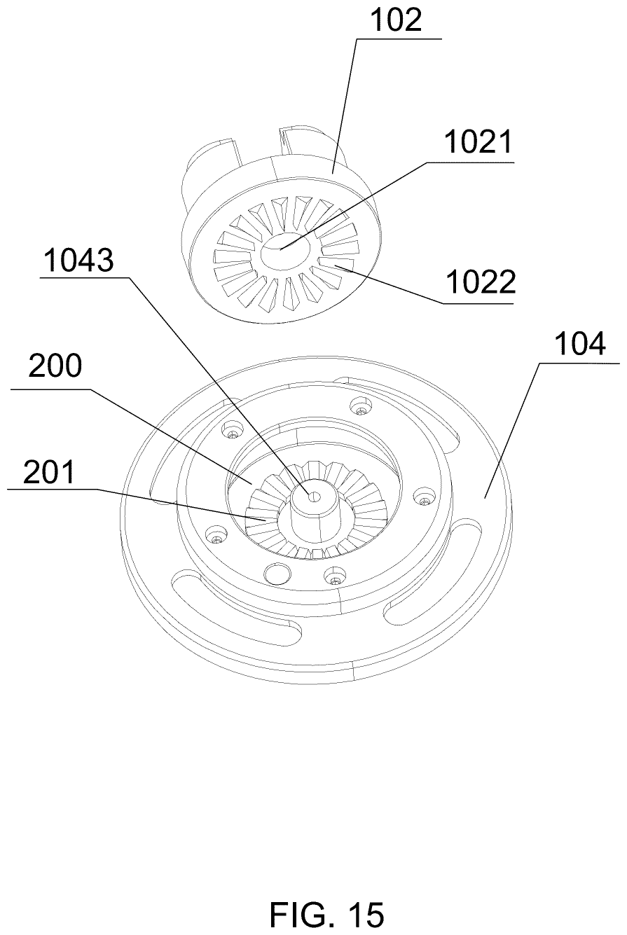

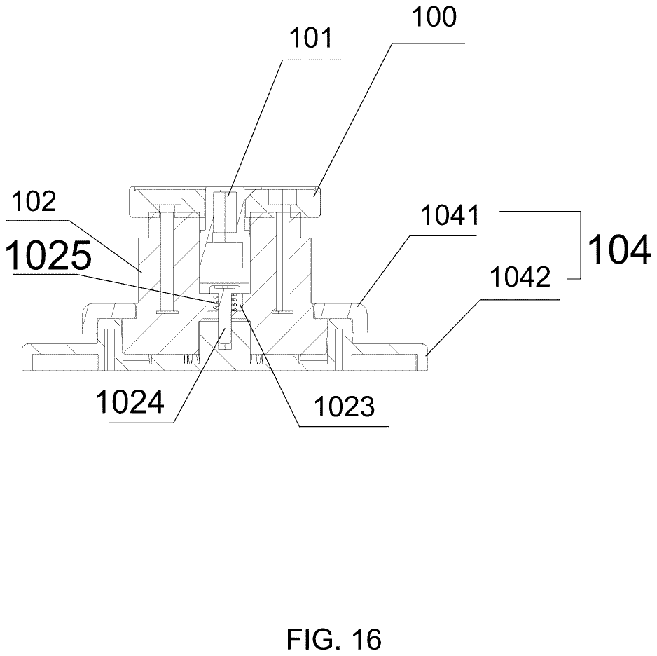

As shown in FIGS. 15 and 16, the bottom seat 102 is circularly provided with first tooth patterns 1022, and the first tooth patterns 1022 are positioned at a bottom surface portion of the bottom seat 102. The fixed seat 104 is provided with second tooth patterns 201 corresponding to the first tooth patterns 1022, the second tooth patterns 201 are arranged at a bottom surface portion of the rotating groove 200, the second tooth patterns 201 are circularly arranged on a periphery of the rotating shaft 1043, and the first tooth patterns 1022 are meshed with the second tooth patterns 201 in a fitted manner. The bottom seat 102 is provided with an avoidance groove 1023 with a certain depth, the avoidance groove 1023 is provided opposite the shaft groove 1021 in the bottom seat 102 up and down, and the shaft groove 1021 is positioned at a central position of the bottom seat 102. A connecting screw rod 1024 and a third elastic body 1025 arranged on the connecting screw rod 1024 in a sleeving manner are arranged in the avoidance groove 1023, a spring serves as the third elastic body 1025, and the connecting screw rod 1024 penetrates the avoidance groove 1023 and the shaft groove 1021, and is in threaded connection to the fixed seat 104. The bottom seat 102 is rotationally connected to the fixed seat 104, a bottom end of the third elastic body 1025 abuts against a bottom of the avoidance groove 1023, and a top end of the third elastic body 1025 abuts against a screw cap of the connecting screw rod 1024 to form an elastic compression state for the bottom seat 102. The third elastic body 1025, the first tooth patterns 1022 and the second tooth patterns 201 are arranged, such that the bottom seat 102 has certain damping force when rotating so as to prevent the side pillow 22 from rotating at will after rotation adjustment and prevent user experience from being influenced.

### Example 4

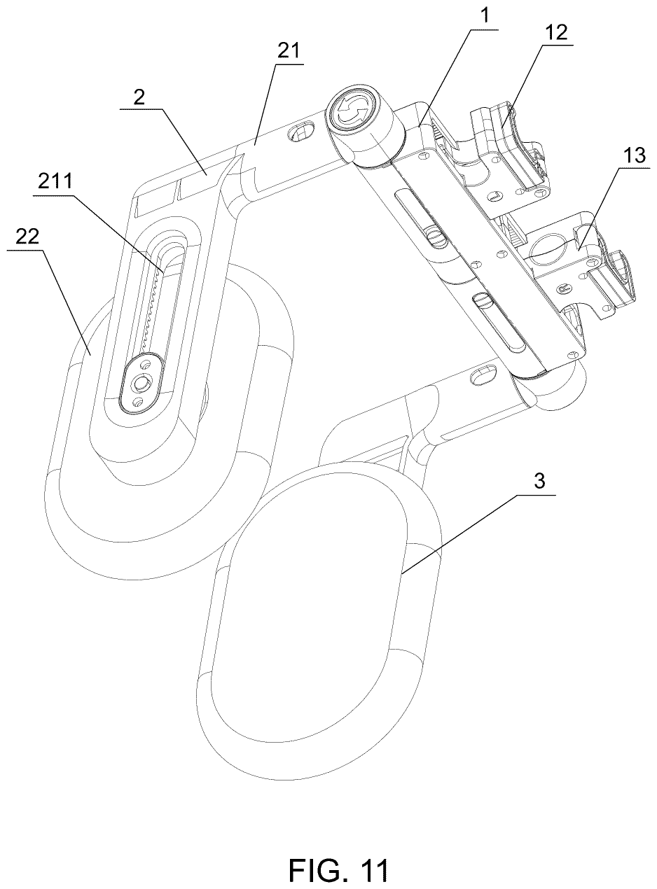

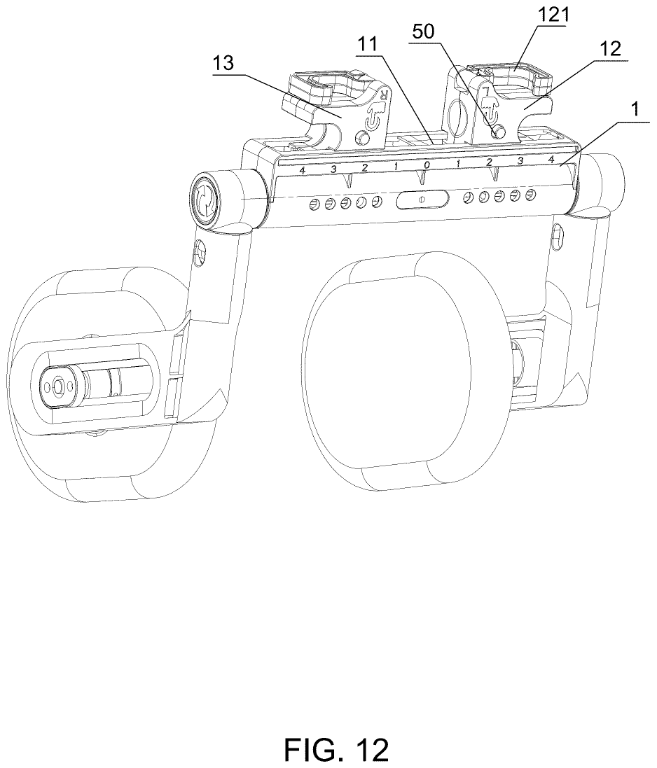

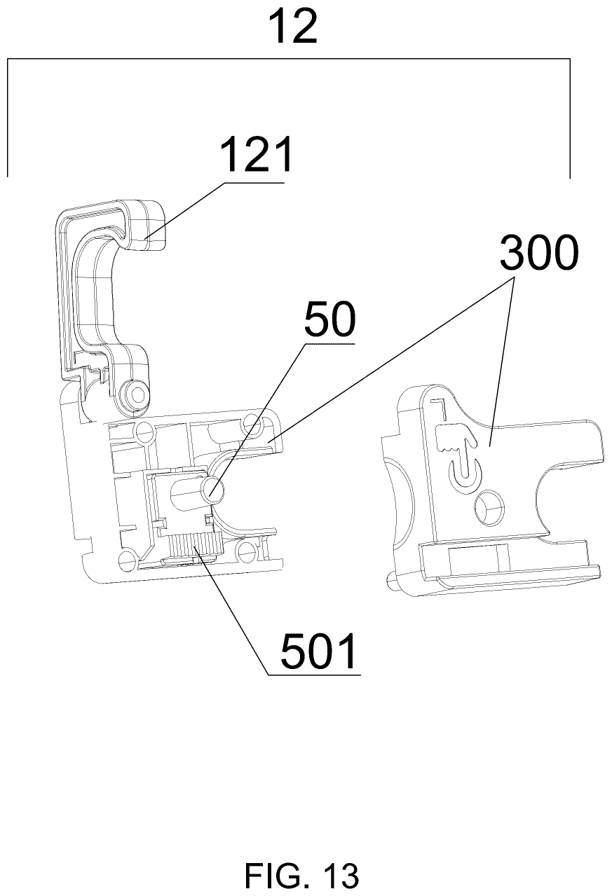

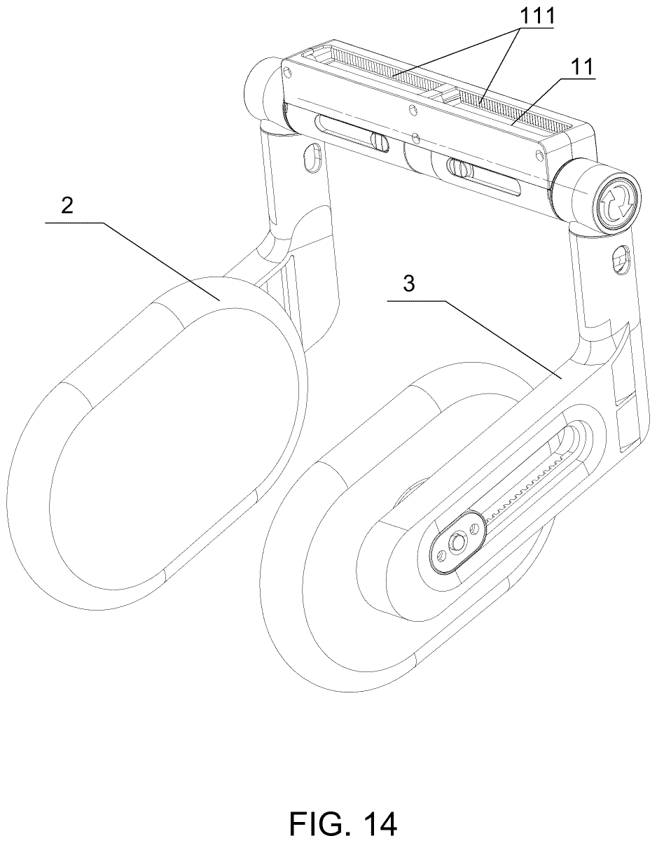

As shown in FIGS. 11-14, the base 1 includes a sliding groove 11 provided in a housing body of the base 1, and a left clamping arm assembly 12 and a right clamping arm assembly 13 that are arranged on the sliding groove 11 in a left-right sliding manner. The sliding groove 11 is transversely provided in the housing of the base 1, the sliding groove 11 extends from a left end to a right end of the housing body of the base 1, and the sliding groove 11 is provided as a two-segment groove body or a linear groove body with two ends communicating with each other. The left clamping arm assembly 12 and the right clamping arm assembly 13 have the same mirror image or non-mirror image structure. In this example, the left clamping arm assembly 12 and the right clamping arm assembly 13 have the same mirror image structure. The left clamping arm assembly 12 includes a housing 300 and a hook 121 rotationally connected to the housing 300, and the hook 121 is used for hanging a garbage bag or other articles. Locking mechanisms are mounted inside the left clamping arm assembly 12 and the right clamping arm assembly 13, and the locking mechanisms are used for locking the left clamping arm assembly 12 and the right clamping arm assembly 13. Each locking mechanism includes first tooth patterns 111 arranged on a side wall of the sliding groove 11. Each locking mechanism further includes a key body 50 and a second elastic body 1031 that are arranged inside the housing 300, and the second elastic body 1031 is positioned below the key body 50 and elastically abuts against the key body. A spring or other structural body having certain elasticity and resilience serves as the second elastic body 1031, and the second elastic body 1031 is used for pressing and resetting the key body 50. The key body 50 is provided with second tooth patterns 501, and the second tooth patterns 501 are meshed with the first tooth patterns 111 on the side wall of the sliding groove 11. The key body 50 penetrates the corresponding housing 300, and the key body 50 is connected to the housing 300 through pressing. When the second tooth patterns 501 on the key body 50 are meshed with the first tooth patterns 111 on the side wall of the sliding groove 11, the left clamping arm assembly 12 and the right clamping arm assembly 13 are locked, and in this case, the left clamping arm assembly 12 and the right clamping arm assembly 13 cannot be adjusted left and right.

Thus, when the user needs to adjust a distance between the left clamping arm assembly 12 and the right clamping arm assembly 13, the user only needs to press the key body 50, the second elastic body 1031 is deformed and retracted, and the second tooth patterns 501 on the key body 50 are separated from the first tooth patterns 111 on the side wall of the sliding groove 11. In this case, the left clamping arm assembly 12 and the right clamping arm assembly 13 are unlocked.

Working principle: when in use, the left clamping arm assembly 12 and the right clamping arm assembly 13 are adjusted to achieve the appropriate distance, and then clamped on two metal connecting rods of a headrest of a vehicle seat. Next, the key bodies 50 on the left clamping arm assembly 12 and the right clamping arm assembly 13 are pressed. When the locking mechanisms are in an unlocked state, the distance between the left clamping arm assembly 12 and the right clamping arm assembly 13 is reduced until the left clamping arm assembly 12 and the right clamping arm assembly 13 are firmly clamped on the two metal connecting rods, thereby completing mounting of the vehicle-mounted headrest.

If the user needs to adjust the supporting positions of the side pillows 22 to the two sides of the head of the user, the user can press the key column 1001 on each release key 101. In this case, the first elastic body 105 is compressed to generate deformation, and the second teeth 10 on the release key 101 and the first teeth 20 on the sliding hole 211 are separated. In this case, the corresponding side pillow 22 is pushed to a proper height to reach the most comfortable state of supporting the two sides of the head of the user, such that the applicability and comfort of the vehicle-mounted headrest are improved. Moreover, the user can also rotate the side pillow 22 in the horizontal direction to adapt to more different scenarios and users for use.

To sum up, compared with the prior art, the present disclosure has the advantages as follows: the sliding hole 211 is provided in each connecting rod 21, and each side pillow 22 is connected to the corresponding connecting rod 21 in an up-and-down sliding manner through the connecting mechanism, such that the user can adjust the heights of the side pillows 22, the side pillows can be more closely attached to both sides of the head of the user, the comfort of use is improved, and the applicability is stronger. The connecting mechanisms are arranged, and the bottom seats 102 and the fixed seats 104 on the connecting mechanisms are rotationally connected, such that each side pillow 22 fixedly connected to the corresponding fixed seat 104 can rotate in the horizontal direction, the supporting angle of the side pillow 22 can be adjusted, and the effect of being very practical is achieved.

Moreover, the damping assemblies 103 arranged on each connecting mechanism are used for making the corresponding side pillow 22 have certain damping force during rotation, and the stroke angle of rotation of the side pillow 22 can also be locked to prevent the side pillow 22 from rotating at will and prevent experience during use from being influenced.

The foregoing are merely the preferred embodiments of the present disclosure and are not intended to limit the present disclosure, and various modifications and changes may be made by those skilled in the art. Any modifications, equivalent substitutions, improvements, etc. within the spirit and principles of the present disclosure are intended to fall within the scope of protection of the present disclosure.

What is claimed is:

1. A vehicle-mounted headrest, comprising a base, and a left side pillow assembly and a right side pillow assembly that are fixedly or detachably connected to two opposite ends of the base, wherein the left side pillow assembly and the right side pillow assembly have the same mirror image or non-mirror image structure; and
the left side pillow assembly comprises a connecting rod, a side pillow and a connecting mechanism fixedly arranged on the side pillow, the side pillow on the left side pillow assembly and the side pillow on the right side pillow assembly are used for forming a supporting effect on a left side and a right side of a head of a user, a sliding hole with a certain length is provided in each connecting rod, and the side pillow slides up and down along the corresponding sliding hole and is rotationally connected on the corresponding connecting rod in a horizontal direction.

2. The vehicle-mounted headrest according to claim 1, wherein each connecting mechanism comprises a cover plate, a release key, a bottom seat, a fixed seat and a first elastic body, the release key is arranged above the bottom seat, the fixed seat is fixedly mounted on the side pillow, a rotating groove is provided at the fixed seat, and the bottom seat is mounted in the rotating groove and rotationally connected to the fixed seat.

3. The vehicle-mounted headrest according to claim 1, wherein first teeth are arranged on an inner side of the sliding hole and closest to an edge of an opening of the sliding hole at equal intervals, and the first teeth are arranged at an upper end and a lower end of the sliding hole or at any one of the upper end and the lower end.

4. The vehicle-mounted headrest according to claim 2, wherein the bottom seat is provided with a mounting cavity with a certain depth, the first elastic body and the release key are both arranged in the mounting cavity, the first elastic body is arranged below the release key, and one end of the first elastic body elastically abuts against the release key.

5. The vehicle-mounted headrest according to claim 2, wherein the release key comprises second teeth arranged on the release key and a raised key column, the key column penetrates the corresponding cover plate, the second teeth on the release key are arranged corresponding to the first teeth on the sliding hole, the second teeth are meshed with the first teeth, and when the second teeth are meshed with the first teeth, a stroke of sliding up and down of the side pillow is locked.

6. The vehicle-mounted headrest according to claim 2, wherein the bottom seat is in a T-shaped structure, one end of the bottom seat passes through the sliding hole in the connecting rod, the cover plate is fixedly connected to the bottom seat through a screw or buckle, and a gap with a certain width is provided between the cover plate and the bottom seat so as to facilitate upward and downward sliding of the connecting mechanism.

7. The vehicle-mounted headrest according to claim 1, wherein each connecting mechanism further comprises several damping assemblies, the damping assemblies are embedded at a bottom of the bottom seat, and the damping assemblies are arranged to increase damping force when the side pillow rotates in the horizontal direction.

8. The vehicle-mounted headrest according to claim 7, wherein each damping assembly comprises a housing body, and a second elastic body and a ball that are arranged inside the housing body, the ball is arranged above the second elastic body, and the ball elastically abuts against the second elastic body.

9. The vehicle-mounted headrest according to claim 2, wherein several hemispherical grooves are circularly at a bottom of the rotating groove, the hemispherical grooves are provided corresponding to the damping assemblies one by one, and when the balls on the damping assemblies are clamped into the hemispherical grooves, a rotation angle of the side pillow in the horizontal direction is locked.

10. The vehicle-mounted headrest according to claim 2, wherein the bottom seat is circularly provided with first tooth patterns, the fixed seat is provided with second tooth patterns corresponding to the first tooth patterns, the first tooth patterns are meshed with the second tooth patterns in a fitted manner, the bottom seat is provided with an avoidance groove with a certain depth, a connecting screw rod and a third elastic body arranged on the connecting screw rod in a sleeving manner are arranged in the avoidance groove, the connecting screw rod penetrates the avoidance groove and is in threaded connection to the fixed seat, a bottom end of the third elastic body abuts against a bottom of the avoidance groove, and a top end of the third elastic body abuts against a screw cap of the connecting screw rod to form an elastic compression state for the bottom seat.
